(19) United States
(12) Patent Application Publication
(10) Pub. No.: US 2012/0051734 A1
(43) Pub. Date: Mar. 1, 2012

(54) STATUS MONITOR TRANSPONDER FOR AN OPTICAL NODE OF A NETWORK

(75) Inventors: Thomas M. Weiss, Hatfield, PA (US); Chris S. Petrick, Lansdale, PA (US)

(73) Assignee: GENERAL INSTRUMENT CORPORATION, Horsham, PA (US)

(21) Appl. No.: 12/862,113

(22) Filed: Aug. 24, 2010

(51) Int. Cl. H04B 10/08

(52) U.S. Cl. 398/9

(57) ABSTRACT

A transponder and system for monitoring the status of equipment, such as an optical node, on a network are described. The transponder has an external fiber optic input connection element, an external fiber optic output connection element, an internal receiver connected to the input connection element for converting incoming optical signals to electrical RF signals for use internally within the transponder, and an internal transmitter connected to the output connection element for converting outgoing electrical RF signals to optical signals to be transmitted from the transponder. The transponder also includes status monitoring circuitry interfacing with equipment being monitored and a cable modem communicating with the status monitoring circuitry for receiving information therefrom and for generating an outgoing signal. A method of monitoring the status of an optical node on a network is also disclosed.

### FIELD

A status monitoring system to remotely monitor the health and performance of a network is disclosed, and more particularly, a status monitoring transponder device for an optical collector node, optical hub node, all-optical node or the like of a network is provided.

### BACKGROUND

By way of example, a Hybrid Fiber Coaxial (HFC) cable television system includes a headend which provides communications between end users in the HFC network and IP/PSTN networks. The headend typically contains a Cable Modem Termination System (CMTS) that hosts downstream and upstream ports and that contains numerous receivers, each receiver handling communications between hundreds of end user network elements. An example of a CMTS is the Motorola Broadband Service Router 64000 (BSR 64000).

Depending upon system architecture, the headend is typically connected to several nodes and some or most of the nodes are connected to many network elements. Examples of network elements include cable modems, set top boxes, televisions equipped with set top boxes, Data Over Cable Service Interface Specification (DOCSIS) terminal devices, media terminal adapters (MTA), and the like. For instance, a single node may be connected to hundreds of modems.

A typical HFC network uses optical fiber for communications between the headend and the nodes and coaxial cable for communications between the nodes and the end user network elements. Downstream (also referred to as forward path) optical communications over the optical fiber are typically converted at the nodes to Radio Frequency (RF) communications for transmission over the coaxial cable. Conversely, upstream (also referred to as return path) RF communications from the network elements are provided over the coaxial cables and are typically converted at the nodes to optical communications for transmission over the optical fiber to the headend.

A status monitoring system may be utilized in a HFC network to remotely monitor the health and performance of the network, more specifically, the health and performance of optical nodes which generally represent a relatively-high investment to the network operator. Typically, a status monitor transponder module is located within each optical node and receives RF signals concerning status monitoring issues from the headend and, in response, transmits desired status monitoring information and parameters via RF signals to the headend.

Conventionally, HFC network operators have used vendor proprietary status monitoring systems that require specialized equipment at the headend or hub and relatively-high capital and operational expenditures associated with the purchase and use of such specialized equipment. For example, the vendor proprietary system requires a Headend Controller (HEC), Hybrid Management Sub-Layer (HMS) system, Headend Management Termination System (HMTS) or like specialized equipment connected to the CMTS at the headend.

This specialized equipment communicates via Frequency Shift Keying (FSK) signals with status monitor transponder devices mounted within nodes of the network. The FSK signals are combined with broadcast signals into an optical transmitter, such as a laser transmitter, at the headend and output on fiber transmission to the node locations. At the node, an optical receiver module within the node decouples the optical signal and converts the broadcast and status monitoring signals to electrical RF signals. The RF status monitoring signal is sampled via a coupler and directed into the status monitor transponder. Likewise, in the upstream direction, the responsive RF signal generated by the status monitor transponder is combined with additional return path traffic into an optical or laser transmitter module in the node and output as fiber transmission to the headend. An optical receiver at the headend decouples the optical signal and converts the return path and status monitor signals into RF signals. The status monitor RF signal is then routed to the HEC, HMTS or other vendor proprietary specialized status monitoring equipment for purposes of performing status monitoring functions.

As an option to the use of vendor proprietary specialized status monitoring systems, operators of HFC networks have more recently used DOCSIS cable modems in status monitor transponder devices in place of the FSK modems required of transponders of vendor proprietary systems. The use of DOCSIS cable modems in status monitor transponders permits status monitoring data to be retrieved directly from the CMTS in the headend. Thus, an advantage of status monitor transponders having a DOCSIS cable modem is that the need for an HEC, HMTS, or other specialized equipment at the headend is eliminated thereby reducing capital expenditures and operational costs. In addition, operators of HFC networks, in particular, are typically very familiar with industry standard DOCSIS systems, networks and functionality and such DOCSIS-based systems may be preferred for this reason.

A problem with the above referenced status monitoring systems and transponders is that they necessarily require light-wave to RF (optical to electrical) and RF to light-wave (electrical to optical) conversions of signals within the node at the location of the node. However, fiber is being deployed deeper into the networks and traditional HFC nodes are being converted to all-optical or optical-only nodes in which there is simply no need for light-wave/RF or optical/electrical conversions with respect to broadcast signals and return path traffic at the node. Also, when nodes are deployed in networks in advanced optical collector or hub node architectures, there is often no optical-to-electrical signal conversion because there are no subscribers connected directly to the node.

With respect to the all-optical or optical-only nodes, an operator can simply choose not to monitor the status of the node despite its high investment cost to the operator, or alternatively, can add an optical receiver module and an optical transmitter module to the node solely to provide the necessary input and output of status monitoring signals (i.e., the primary functions of these modules with respect to conversion of broadcast signals and return path traffic signals is not required). The disadvantages of adding the separate optical receiver and transmitter modules to such a node include increased capital and operational cost of the node, increased power consumption of the node, and consumption of physical module slot locations within the node enclosure that necessarily precludes operators from deploying other more desirable modules or features in the node.

### SUMMARY

This disclosure describes a status monitor transponder having an external fiber optic input connection element and an external fiber optic output connection element. An internal receiver of the transponder connects to the external fiber optic input connection element for converting optical signals incoming via the fiber optic input connection element to electrical RF signals for use internally within the transponder and an internal transmitter of the transponder connects to the external fiber optic output connection element for converting outgoing electrical RF signals to optical signals to be transmitted from the transponder via the external fiber optic output connection element. The transponder also includes status monitoring circuitry having a serial peripheral interface connected to equipment being monitored and a cable modem communicating with the status monitoring circuitry for receiving status monitoring information therefrom and for generating an outgoing electrical RF signal based on the information. Before the outgoing signal is transmitted from the transponder it is converted internally to an optical signal which is applied to the optical fiber output connection element of the transponder.

This disclosure also describes a system for monitoring the status of an optical node of a network. A headend or hub of the network has a cable modem termination system (CMTS) and an optical transceiver, and an optical node communicates with the CMTS via downstream and upstream optical signals transmitted over optic fibers. A status monitoring transponder module is mounted within the optical node and has a fiber optic input connection element, a fiber optic output connection element, status monitoring circuitry having a serial peripheral interface connected to equipment in the node being monitored, and a cable modem communicating with the status monitoring circuitry for receiving status monitoring information therefrom. The cable modem generates an outgoing signal to the headend or hub based on the information.

This disclosure further describes a method for monitoring the status of an optical node, power supply, or other unit or piece of equipment on a network. An optical status monitoring signal received via fiber optics from a headend or hub of the network is coupled directly to an external optical input connection element of a status monitoring transponder module without a first step of performing optical to electrical RF signal conversion. Thereafter, the optical signal is converted to an electrical RF signal within the transponder module with an internal receiver integrated on the status monitoring module and provided to a cable modem also integrated on the status monitoring module. The cable modem generates an outgoing electrical RF status monitoring signal which is converted to an outgoing optical signal within the transponder module with an internal transmitter integrated on the status monitoring module. The outgoing optical signal is coupled from an external fiber optic output connection element of the status monitoring transponder module to the optic fibers along a return path to the headend or hub.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a diagram of a network including an optical node having a status monitoring transponder with a DOCSIS compliant cable modem;

FIG. 2 is a block diagram of a first embodiment of an optical transponder module having an optical input and an optical output;

FIG. 3 is a block diagram of a second embodiment of an optical transponder module having an optical input and an optical output;

FIG. 4 is a block diagram of an all-optical or optical-only node configuration having the transponder module of FIG. 3; and

FIG. 5 is a block diagram of method steps for a method of monitoring the status of equipment, such as optical nodes, power supplies, or the like on a network.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Before turning to detailed descriptions with respect to a transponder module, a description of a basic network set-up and associated apparatus and elements is provided.

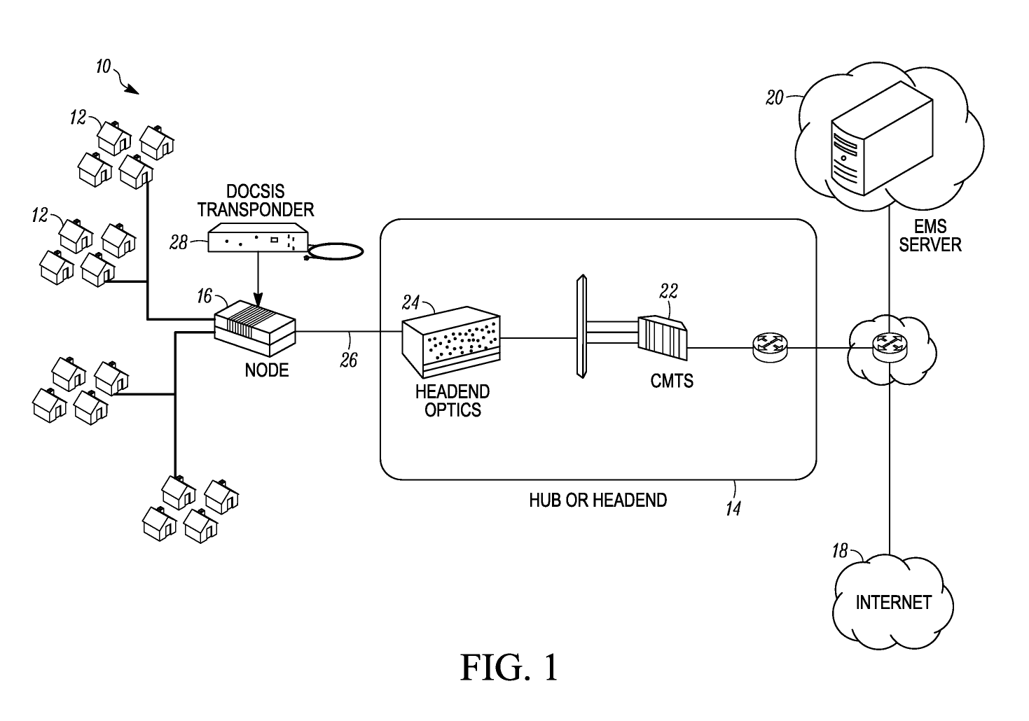

For this purpose and by way of example, FIG. 1 illustrates an exemplary network 10, such as an HFC network, including a plurality of end user locations 12 having terminal network elements (not shown), such as cable modems, set top boxes, televisions equipped with set top boxes, DOCSIS terminal devices, MTAs or any other like element. As illustrated in FIG. 1, the terminal network elements interconnect to a headend or hub 14 of the network 10 via an optical node 16. In turn, the headend or hub 14 interconnects to an IP (Internet Protocol) network 18 and an Element Management System (EMS) server 20.

The headend 14 includes a Cable Modem Termination System (CMTS) unit 22 and optical transceivers 24 which provide electrical to optical and optical to electrical conversions for the CMTS 22 so that optical communications can be transmitted/received via optical fiber 26 connecting the headend 14 and the node 16. Typically, a plurality of nodes 16 connect to the headend 14, the headend 14 contains a plurality of CMTS units 22, and each CMTS 22 contains a plurality of receivers which communicate with a plurality of network elements. For example, each CMTS 22 may have eight or more receivers, and each receiver may communicate with hundreds of network elements.

A transponder module 28, such as a status monitor transponder module, is mounted within one of a finite number of available module slots in the optical node 16. The transponder module 28 includes a DOCSIS-compliant cable modem for receiving and transmitting DOCSIS-compliant transmissions from and to the headend 14 on a DOCSIS channel which is used for providing status monitoring communications between the transponder and headend. Accordingly, there is an absence of vendor proprietary specialized status monitoring equipment in the headend 14 in FIG. 1 because such equipment is not needed. Rather, status monitoring data received by the headend 14 from transponder 28 is retrieved directly from the CMTS 22 in the headend 14 without the need of vendor proprietary specialized status monitoring equipment.

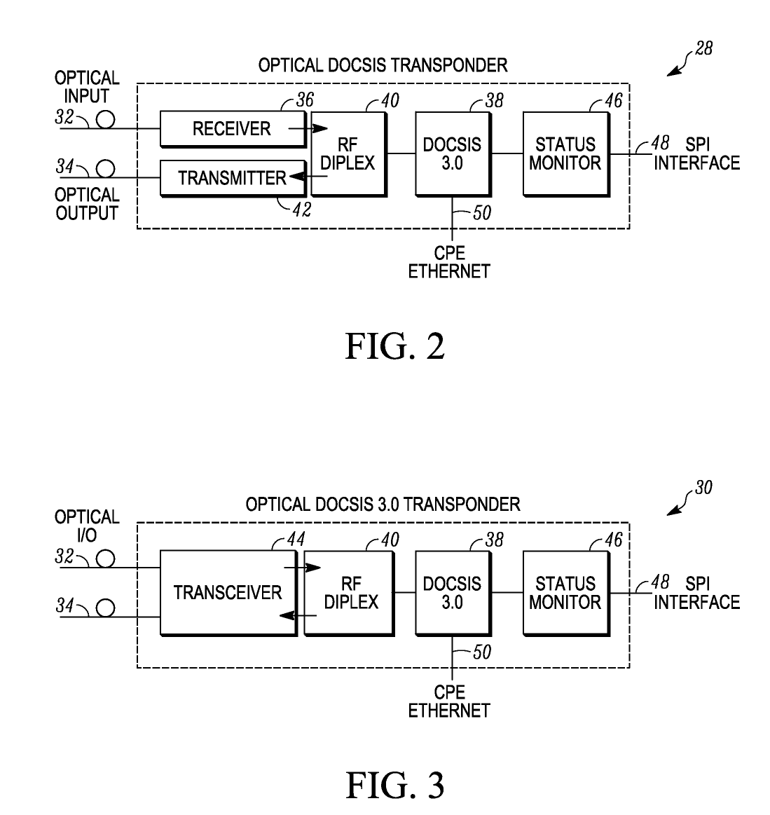

The transponder module 28 shown in FIG. 2 and an alternate embodiment of a transponder module 30 illustrated in FIG. 3 each includes a fiber optic input connection element 32 and a fiber optic output connection element 34 such that the downstream (input) and upstream (output) signals received and transmitted by each of the single transponder modules 28 and 30 are optical or light-wave signals. As explained in greater detail below, the transponder module in node 16 can be directly coupled to the optic fiber, such as optic fiber 26 shown in FIG. 1, and does not require light-wave to RF or optical to electrical and RF to light-wave or electrical to optical conversions to occur elsewhere in the node 16 external of the transponder modules. Accordingly, each of the transponder modules 28 and 30 is particularly useful in an all-optical or optical-only node such as used in advanced optical collector or hub node architectures where there is no conversion of signals and all signals are light-wave or optical signals elsewhere within the node. A further benefit of the optical input 32 and an optical output 34 of the transponder module is that separate optical receiver and transmitter modules are not required in the node thereby reducing capital and operational cost of the node, power consumption of the node, and consumption of physical module slot locations within the node enclosure.

The transponder module 28 of FIG. 2 includes an internal receiver 36, such as an integrated broadband photo detector, that converts the incoming optical signal from the optical input 32 to an RF signal within the transponder module. The RF signal is provided to the DOCSIS-compliant cable modem 38 via a RF diplexer 40. The transponder module 28 also includes an internal transmitter 42 which converts the outgoing RF signal from the DOCSIS-compliant cable modem 38 via the RF diplexer 40 to an optical signal within the transponder module and provides the internally-generated optical signal to the optical output 34.

As an alternate embodiment, the transponder module 30 shown in FIG. 3 is similar to transponder module 28 except that a single transceiver 44 is utilized and provides receiver and transmitter functionality. The transceiver 44 may be a Small Form Pluggable (SFP) optics transceiver which is able to provide a unique wavelength for the laser transmitter of the transceiver to be selected for the outgoing status monitor signal that does not interfere with other wavelengths which may be aggregated on the optic fiber 26.

As shown in FIGS. 2 and 3, the DOCSIS-compliant cable modem 38 communicates with internal status monitoring circuitry 46 which includes a Serial Peripheral Interface (SPI) 48 or other interface that enables exchange of data between the status monitoring circuitry 46 and the equipment (not shown) in the node being monitored. Thus, the modem 38 receives a command from the headend 14 on the DOCSIS RF channel dedicated for such communications and is provided with the requested status monitoring node enclosure information from the status monitoring circuitry 46. The modem transmits this information on an upstream DOCSIS RF channel which is converted to an optical signal before being transmitted from the transponder module. The status monitoring information includes information, parameters and/or data concerning node operation, performance, health and/or status.

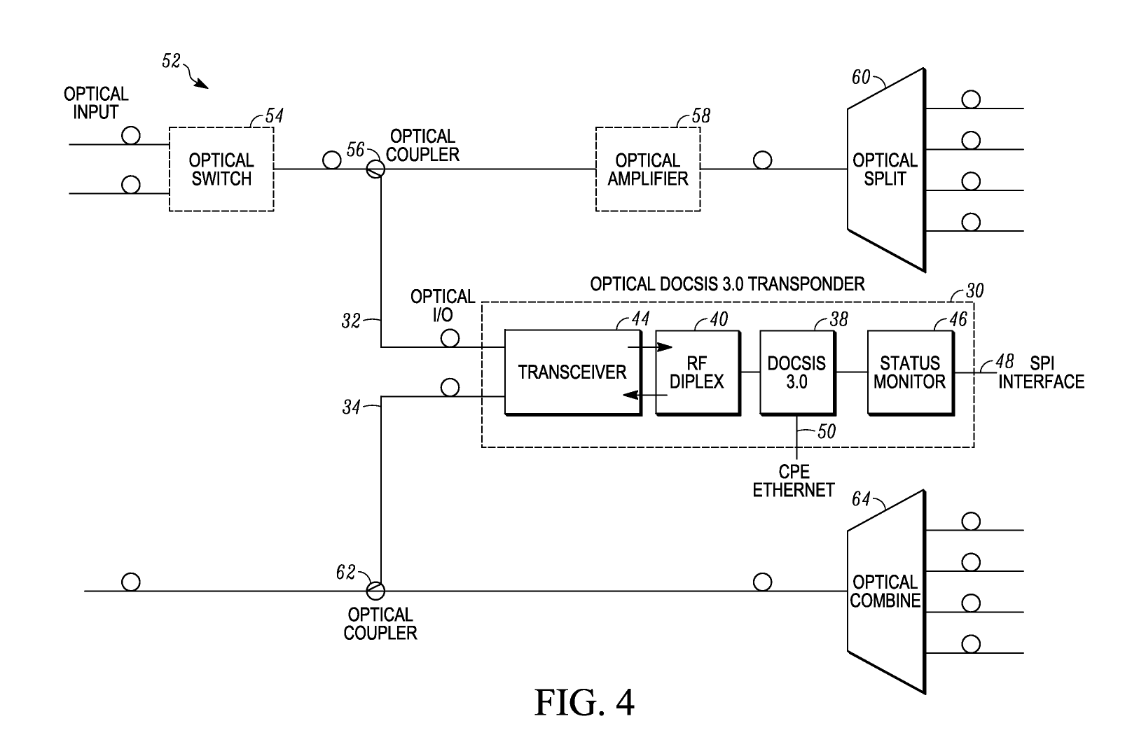

FIG. 4 is a block diagram of a node 52 that is an all-optical or optical-only node such as provided in an optical collector or hub node configuration. One of the module slots of node 52 includes the status monitor transponder module 30 and none of the module slots of node 52 (other than the transponder module) includes modules dedicated to converting optical signals to electrical signals or to converting electrical signals to optical signals. Accordingly, the downstream optical signal provided from the headend is received by the node 52 via optical switch 54 and the signal corresponding to the DOCSIS channel for status monitoring is coupled into the optical input 32 of the transponder module 30 via a passive coupler 56. The downstream optical signal from the headend is also passed to an optical amplifier 58 and optical splitter 60 where it is transmitted from the node 52. In the upstream direction, the transponder module 30 transmits a status monitoring optical signal on a DOCSIS channel at a specific wavelength via its optical output 34 to a passive optical coupler 62 which couples the signal with return path traffic received via optical combiner 64 thereby transmitting the signal to the headend.

In some contemplated embodiments of the transponder modules, the DOCSIS-compliant cable modem is a DOCSIS 3.0 cable modem or cable modem of like functionality. DOCSIS 3.0 standards were released in August 2006 and provide significantly increased transmissions speeds for both upstream and downstream transmissions. Thus, as discussed above, using the DOCSIS protocol in the status monitor transponder modules eliminates the need for vendor proprietary specialized status monitoring equipment in the headend.

In addition, the DOCSIS-compliant cable modem in the transponder module includes an Ethernet port 50 which can be accessed to diagnose node health and performance by a technician at the node location using only a laptop computer or the like with an Internet browser. The Ethernet port 50 can be configured with a unique IP address thereby enabling a technician to remotely access node health and performance via the Internet without having to be physically located at the headend or the node location. Thus, the Ethernet port 50 provided by the DOCSIS 3.0 compliant cable modem of the status monitoring transponder module can be used for local and/or remote troubleshooting of node operation.

Further, the Ethernet port 50 can function as a Customer Premise Equipment (CPE) device and/or can be used to provide a Power over Ethernet (PoE) service to provide electrical power to nearby equipment such as a wireless access point. By way of example, IP traffic such as wireless access point backhaul or IP video from a surveillance camera can be carried over the network via the Ethernet port 50. The use of DOCSIS 3.0 channel bonding, in particular, provides greater CPE port throughput for such services. By way of further example, a fiber connection can be made from the Ethernet port 50 to a nearby business, MDU, cellular tower, shopping center or the like to provide commercial DOCSIS CPE services, T1/E1 backhaul services, data services or the like.

The transponder modules described above can be used to monitor and control any type of optical fiber node including, for instance, HFC nodes, Passive Optical Network (PON) nodes, Radio Frequency over Glass (RFoG) nodes, and the like. In addition, the transponder modules can be used to monitor and control power supplies installed in a network. Further, the transponder modules can be used in an End of Line Device to monitor the integrity of the signal transmitted on optical fiber and can be used to monitor and control an RFoG Optical Network Unit (ONU) or installed on the RFoG ONU.

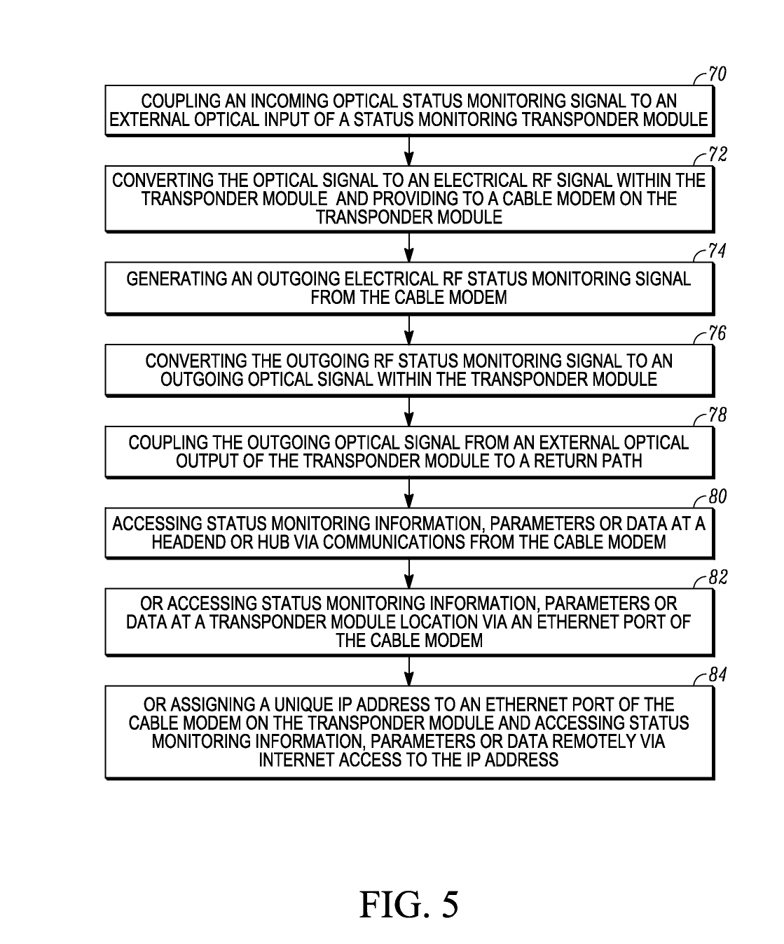

By way of example, FIG. 5 shows the steps of a method for monitoring the status of a piece of equipment, such as an optical node, power supply or the like on a network. An optical status monitoring signal received via fiber optics from a headend or hub of the network is coupled directly to an external optical input connection element of a status monitoring transponder module without a first step of performing optical to electrical RF signal conversion. See step 70. Thereafter, the optical signal is converted to an electrical RF signal within the transponder module with an internal receiver or transceiver integrated on the status monitoring module and provided to a cable modem also integrated on the status monitoring module. See step 72. The cable modem generates an outgoing electrical RF status monitoring signal which is converted to an outgoing optical signal within the transponder module with an internal transmitter or transceiver integrated on the status monitoring module. See steps 74 and 76. The outgoing optical signal is coupled from an external optical output connection element of the status monitoring transponder module to the optic fibers along a return path to the headend or hub. See step 78. The status monitoring information, parameters or data can be accessed at the headend or hub via communications from the cable modem (see step 80), or can be accessed at the transponder module location via an Ethernet port of the cable modem (see step 82), or if a unique IP address is assigned to the Ethernet port of the cable modem, can be accessed remotely via Internet access to the IP address (see step 84).

While the principles of the invention have been described above in connection with specific devices, systems, and methods, it is to be clearly understood that this description is made only by way of example and not as limitation on the scope of the invention as defined in the appended claims.

We claim:

1. A status monitor transponder, comprising:
an external fiber optic input connection element;
an external fiber optic output connection element;
an internal receiver connected to said fiber optic input connection element for converting optical signals incoming via said fiber optic input connection element to electrical RF signals for use internally within the transponder;
an internal transmitter connected to said fiber optic output connection element for converting outgoing electrical RF signals to optical signals to be transmitted from the transponder via said fiber optic output connection element;
status monitoring circuitry having a serial peripheral interface connected to equipment being monitored; and
a cable modem communicating with said status monitoring circuitry for receiving status monitoring information from said status monitoring circuitry and for generating an electrical RF signal based on said information.

2. A status monitor transponder according to claim 1, wherein said external fiber optic input connection element, said external fiber optic output connection element, said internal receiver, said internal transmitter, said cable modem, and said status monitoring circuitry are integrated within a single module for mounting within a single module slot within an optical node.

3. A status monitor transponder according to claim 1, wherein said cable modem is selected from the group consisting of a DOCSIS-compliant cable modem and a DOCSIS 3.0 compliant cable modem.

4. A status monitor transponder according to claim 1, wherein said cable modem has an externally accessible Ethernet port.

5. A status monitor transponder according to claim 1, wherein an internal transceiver comprises said internal receiver and said internal transmitter.

6. A status monitor transponder according to claim 5, wherein said transceiver is a Small Form Pluggable (SFP) optics transceiver including a laser transmitter settable to transmit optical signals at a wavelength selected from a range of wavelengths.

7. A status monitoring transponder according to claim 1, further comprising a RF diplexer interconnecting said cable modem with said internal receiver and internal transmitter for transferring electrical RF signals therebetween.

8. A system for monitoring the status of an optical node of a network, comprising:
a cable modem termination system (CMTS) and an optical transceiver at a first network location selected from the group consisting of a headend and a hub;
an optical node communicating with said CMTS via downstream and upstream optical signals transmitted over optic fibers; and
a status monitoring transponder module mounted within said optical node having a fiber optic input connection element and a fiber optic output connection element coupled to said optic fibers by passive optical couplers, status monitoring circuitry having a serial peripheral interface connected to equipment in said node being monitored, and a cable modem connected to said status monitoring circuitry for receiving status monitoring information from said status monitoring circuitry and for generating an outgoing signal to said first network location based on said information.

9. A system according to claim 8, wherein said transponder module has an internal receiver connected to said fiber optic input connection element for converting incoming optical signals to electrical RF signals and an internal transmitter connected to said fiber optic output connection element for converting outgoing electrical RF signals to optical signals.

10. A system according to claim 9, wherein an internal transceiver comprises said internal receiver and said internal transmitter.

11. A system according to claim 9, wherein said optical node has a pre-determined number of module slots, and wherein said transponder module including said internal receiver and said internal transmitter is mounted within only a single module slot.

12. A system according to claim 8, wherein said optical node is an optical-only node without modules designated solely for converting optical signals to electrical RF signals and for converting electrical RF signals to optical signals.

13. A system according to claim 8, wherein said cable modem is selected from the group consisting of a DOCSIS-compliant cable modem and a DOCSIS 3.0 compliant cable modem, and wherein status monitoring communications between said cable modem and said CMTS is via DOCSIS-compliant transmissions on a DOCSIS channel.

14. A system according to claim 8, wherein said cable modem has an externally accessible Ethernet port, and wherein status monitoring information of said optical node is available at said first network location from said CMTS via communications from said cable modem and at said optical node via connection to said Ethernet port.

15. A system according to claim 8, wherein said cable modem has an externally accessible Ethernet port assigned a unique IP address, and wherein status monitoring information of said optical node is available remotely via Internet access to said IP address.

16. A system according to claim 8, wherein said cable modem has an externally accessible Ethernet port, and further comprising Customer Premise Equipment (CPE) connected to and being provided service from said Ethernet port.

17. A method for monitoring the status of equipment on a network, comprising the steps of:
coupling an optical status monitoring signal received via fiber optics from a first network location selected from the group consisting of a headend and a hub directly to an external fiber optic input connection element of a status monitoring transponder module without performing optical to electrical RF signal conversion;
converting the optical signal to an electrical RF signal within the transponder module with an internal receiver integrated on the status monitoring transponder module for a cable modem integrated on the status monitoring transponder module;
generating from the cable modem an outgoing electrical RF status monitoring signal;
converting the outgoing electrical RF status monitoring signal to an outgoing optical signal within the transponder module with an internal transmitter integrated on the status monitoring transponder module; and
coupling the outgoing optical signal from an external fiber optic output connection element of the status monitoring transponder module to the optic fibers along a return path to the first network location.

18. A method according to claim 17, wherein the cable modem is a DOCSIS-compliant cable modem, and wherein status monitoring communications between the cable modem and the first network location is via DOCSIS-compliant transmissions on a DOCSIS channel.

19. A method according to claim 17, further comprising the step of obtaining status monitoring information by accessing the status monitoring information at the first network location via communications from the cable modem and by accessing the status monitoring information at the transponder module location via an Ethernet port of the cable modem.

20. A method according to claim 17, further comprising the step of obtaining status monitoring information by assigning a unique IP address to an Ethernet port of the cable modem on the transponder module and by accessing the status monitoring information remotely via Internet access to the IP address.

21. A method according to claim 17, further comprising the step of connecting Customer Premise Equipment (CPE) to and providing service from an Ethernet port of the cable modem.

22. A method according to claim 17, further comprising the step of providing Power over Ethernet (PoE) service via the Ethernet port of the cable modem.
